(19) United States
(12) Patent Application Publication
(10) Pub. No.: US 2022/0250925 A1
(43) Pub. Date: Aug. 11, 2022

(54) IZM-5 CRYSTALLISED SOLID AND METHOD FOR PREPARING SAME

(71) Applicant: IFP Energies nouvelles, Rueil-Malmaison Cedex (FR)

(72) Inventors: Antoine FECANT, Rueil-Malmaison Cedex (FR); Raquel MARTINEZ FRANCO, Rueil-Malmaison Cedex (FR)

(73) Assignee: IFP Energies nouvelles, Rueil-Malmaison Cedex (FR)

(21) Appl. No.: 17/622,339

(22) PCT Filed: Jun. 16, 2020
(86) PCT No.: PCT/EP2020/066567

§ 371 Date: Dec. 23, 2021

(30) Foreign Application Priority Data
Jun. 28, 2019 (FR) FR1907098

(51) Int. Cl. C01B 39/46; C01G 19/00

(52) U.S. Cl. CPC C01B 39/46; C01P 2002/72; C01G 19/006

(57) ABSTRACT

The present invention relates to a crystallised solid, called IZM-5, comprising a chemical composition expressed on an anhydrous base, in terms of mole, and defined by the following general formula: SnₐZn_{b}S₈: cR, wherein R represents at least one nitrogenous organic species; S sulphur, “a” is the molar amount of tin, denoted Sn, between 0.1 and 5; “b” is the molar amount of zinc, denoted Zn, between 0.2 and 8; “c” is the molar amount of the nitrogenous organic species R between 0 and 4.

### TECHNICAL FIELD

The present invention relates to a new crystalline solid based on metal sulfides hereinafter referred to as IZM-5, and also to the process for preparing said solid.

### PRIOR ART

Crystalline microporous materials, such as zeolites or silicoaluminophosphates, are solids that are extensively used in the petroleum industry as catalysts, catalyst supports, adsorbents or separating agents. Although many microporous crystal structures of various compositions have been discovered, the refining and petrochemical industry and catalytic processes in general are always searching for new crystalline structures which exhibit particular properties for applications such as the purification or separation of gases, the conversion of carbon-based entities or the like.

Zeolites make up a predominant number of the crystalline structures. Among the zeolites synthesized over the past forty years, a certain number of solids have made it possible to achieve significant progress in the fields of adsorption and catalysis. Among these, mention may be made of Y zeolite (U.S. Pat. No. 3,130,007) and ZSM-5 zeolite (U.S. Pat. No. 3,702,886). The number of new molecular sieves, covering zeolites, synthesized each year is constantly increasing. For a more complete description of the different molecular sieves discovered, it may be useful to refer to the following handbook: “Atlas of Zeolite Framework Types”, Ch. Baerlocher, L. B. McCusker and D. H. Olson, Sixth Revised Edition, 2007, Elsevier.

Among all of these microporous crystalline structures, P. Feng et al. (Science, 298, p; 2366, 2002) discovered the first material of this type based on sulfides of tetravalent metal structural elements (gallium, tin and germanium) and optionally trivalent metal structural elements (indium), named UCR-20 and referenced in “Atlas of Zeolite Framework Types” by the RWY structural code.

Since then, other crystalline sulfide materials have been claimed in the literature (P. Feng, Nature, 426, p. 428, 2003) containing structural elements based on trivalent metals (ICF-21, ICF-22, ICF-24, ICF-25 and ICF-27), trivalent and divalent metals (ICF-5 and ICF-17), and more recently based on tetravalent and divalent structural elements (S. Dehnen et al., Inorg. Chem., 48, p. 1689, 2009; P. Feng et al. J. Am. Chem. Soc., 137, p. 6184, 2015).

However, the metals used in the prior art contain rare and/or expensive and/or toxic structural elements, such as Ga, Ge, In or even Cd.

The present invention proposes to provide a new specific crystalline solid containing zinc and tin, as a structural element, exhibiting a particular X-ray diffraction pattern.

### Subjects of the Invention

A subject of the present invention is a crystalline solid comprising a chemical composition expressed on an anhydrous basis, in terms of moles, defined by the following general formula:

SnₐZn_{b}S₈: Cr

wherein

R represents at least one nitrogenous organic entity;

S is sulfur;

“a” is the molar amount of tin, denoted Sn, between 0.1 and 5;

“b” is the molar amount of zinc, denoted Zn, between 0.2 and 8;

“c” is the molar amount of the nitrogenous organic entity R between 0 and 4.

Preferably, “c” is between 0.2 and 4.

Preferably, said solid has an X-ray diffraction pattern which includes at least the lines listed in the table below:

TABLE 1

| 2 theta (°) | dhkl (Å) | Irel |
|---|---|---|
| 7.95 | 11.11 | St |
| 8.88 | 9.95 | m |
| 10.18 | 8.68 | w |
| 11.10 | 7.97 | VSt |
| 11.72 | 7.54 | St |
| 15.37 | 5.76 | m |
| 16.71 | 5.30 | w |
| 17.36 | 5.11 | w |
| 21.49 | 4.13 | m |
| 22.30 | 3.98 | m |
| 23.31 | 3.81 | w |
| 30.05 | 2.97 | w |
| 33.34 | 2.69 | w |
| 35.96 | 2.50 | w |
| 40.80 | 2.21 | w |

where VSt = very strong;
St = strong;
m = medium;
w = weak.

Preferably, “a” is between 1 and 4.

Preferably, “b” is between 0.2 and 2.

Preferably, “c” is between 0.5 and 3.

Preferably, R is an organic compound comprising at least two nitrogen atoms.

More preferentially, R is 1,3-bis(4-piperidinyl)propane.

Another subject according to the invention relates to a process for preparing a crystalline solid according to the invention, comprising the following steps:
i) at least one source of tin, denoted Sn, at least one source of zinc, denoted Zn, at least one source of sulfur, denoted S, at least one nitrogenous organic compound, denoted R, are mixed to obtain a precursor gel;
ii) heat treatment of said precursor gel obtained on conclusion of step i) is carried out at a temperature of between 120° C. and 250° C., for a period of between 2 days and 21 days.

Preferably, the mixture of step i) comprises the following molar composition:

Sn/Zn: at least 0.1;

S/(Sn+Zn): 0.1 to 20;

R/(Sn+Zn): 0.1 to 20.

Preferably, the mixture of step i) also comprises at least one solvent denoted SOLV comprising at least one aqueous compound denoted A and at least one organic compound denoted 0, said mixture comprising the following molar composition:

Sn/Zn: at least 0.1;

S/(Sn+Zn): 0.1 to 20;

R/(Sn+Zn): 0.1 to 20;

SOLV/(Sn+Zn): 10 to 1000;

A/O: 0.01 to 10.

Preferably, the source of tin is chosen from tin acetate Sn(CH₃CO₂)₄, tin tert-butoxide Sn(OC(CH₃)₃)₄, tin tetrachloride SnCl₄, tin bis(acetylacetonate) dichloride (CH₃COCH═C—(O⁻) CH₃)₂SnCl₂, tin oxide SnO₂, tin in metallic form Sn.

Preferably, the source of zinc is chosen from zinc chloride ZnCl₂, zinc acetate Zn(CH₃CO₂)₂, zinc sulfate ZnSO₄, zinc nitrate Zn(NO₃)₂, zinc oxide ZnO, zinc in metallic form Zn.

Preferably, the source of sulfur is chosen from elemental sulfur S or S₈, sodium sulfide Na₂S, potassium sulfide K₂S, lithium sulfide Li₂S, ammonium sulfide S(NH₄)₂, dimethyl disulfide CH₃SSCH₃.

### DESCRIPTION OF THE FIGURES

Other features and advantages of the process according to the invention will become apparent on reading the following description of non-limiting exemplary embodiments, with reference to the appended figures described below.

FIG. 1 represents the chemical formula of an example of an organic compound used as structuring agent in the synthesis process according to the invention.

FIG. 2 represents the X-ray diffraction (XRD) pattern of the metal sulfide-based crystalline IZM-5 solid obtained according to example 1. The x-axis represents the values of the angles 2theta (2θ), in degrees, the y-axis represents the relative intensity, Irel, given in relation to a scale of relative intensity where a value of 100 is assigned to the most intense line of the X-ray diffraction pattern.

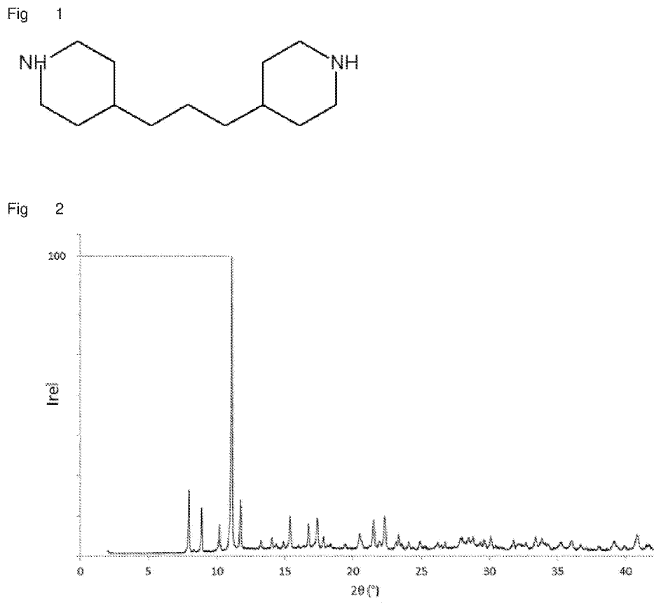

### DESCRIPTION OF THE INVENTION

A subject of the present invention is a new solid, called IZM-5, exhibiting a new crystal structure. Said solid exhibits a chemical composition, expressed on an anhydrous basis, in terms of moles, defined by the following general formula:

SnₐZn_{b}S₈: cR

wherein

R represents at least one nitrogenous organic entity;

S is sulfur;

“a” is the molar amount of tin, denoted Sn, between 0.1 and 5;

“b” is the molar amount of zinc, denoted Zn, between 0.2 and 8;

“c” is the molar amount of the nitrogenous organic entity R between 0 and 4.

The crystalline solid IZM-5 according to the invention advantageously has an X-ray diffraction pattern which includes at least the lines listed in table 2 below. This new crystalline solid IZM-5 has a new crystal structure comprising very specific lines.

This diffraction pattern is obtained by radiocrystallographic analysis by means of a diffractometer using the conventional powder method with the copper Kα₁ radiation (λ=1.5406 Å). On the basis of the position of the diffraction peaks represented by the angle 2θ, the interlattice spacings dₕₖₗ characteristic of the sample are calculated using Bragg's law. The measurement error Δ(dₕₖₗ) on dₕₖₗ is calculated by means of Bragg's law as a function of the absolute error Δ(2θ) assigned to the measurement of 2θ. An absolute error Δ(2θ) equal to ±0.02° is commonly accepted. The relative intensity I_{ref} assigned to each value of dₕₖₗ is measured according to the height of the corresponding diffraction peak. The X-ray diffraction pattern of the IZM-5 crystalline solid according to the invention includes at least the lines at the values of dₕₖₗ given in table 2 below. In the column of dₕₖₗ, we have indicated the mean values of interlattice distances in Angstroms (Å). Each of these values must be assigned the measurement error Δ(dₕₖₗ) of between ±0.6 Å and ±0.01 Å.

TABLE 2

| 2 theta (°) | dhkl (Å) | Irel |
|---|---|---|
| 7.95 | 11.11 | St |
| 8.88 | 9.95 | m |
| 10.18 | 8.68 | w |
| 11.10 | 7.97 | VSt |
| 11.72 | 7.54 | St |
| 15.37 | 5.76 | m |
| 16.71 | 5.30 | w |
| 17.36 | 5.11 | w |
| 21.49 | 4.13 | m |
| 22.30 | 3.98 | m |
| 23.31 | 3.81 | w |
| 30.05 | 2.97 | w |
| 33.34 | 2.69 | w |
| 35.96 | 2.50 | w |
| 40.80 | 2.21 | w |

where VSt = very strong;
St = strong;
m = medium;
w = weak.

The relative intensity Iᵣₑₗ is given in relation to a relative intensity scale where a value of 100 is assigned to the most intense line of the X-ray diffraction pattern: w<10; 10 m≤15; 15≤St<50; VSt≥50.

Said solid IZM-5 exhibits a chemical composition, expressed on an anhydrous basis, in terms of moles, defined by the following general formula:

SnₐZn_{b}S₈: cR

wherein:

“a” is the relative molar amount of Sn between 0.1 and 5, preferably between 1 and 4;

“b” is the relative molar amount of Zn between 0.2 and 8, preferably between 0.2 and 2;

“c” is the molar amount of the nitrogenous organic entity R between 0 and 4, preferably between 0.2 and 4, and more preferentially between 0.5 and 3.

A subject of the present invention is also a process for preparing the crystalline solid IZM-5 comprising at least the following steps:
i) at least one source of tin, denoted Sn, at least one source of zinc, denoted Zn, at least one source of sulfur, denoted S, at least one nitrogenous organic compound, denoted R, also called structuring agent, preferably 1,3-bis(4-piperidinyl)propane, and optionally at least one solvent, denoted SOLV, comprising at least one aqueous compound (denoted A) and/or at least one organic compound (denoted O), are mixed to obtain a precursor gel, said mixture exhibiting preferentially the following molar composition:
   Sn/Zn: at least 0.1, preferably at least 1, more preferably from 2 to 200;
   S/(Sn+Zn): 0.1 to 20, preferably from 1 to 10;
   R/(Sn+Zn): 0.1 to 20, preferably from 1 to 10;
   SOLV/(Sn+Zn): 0 to 1000, preferably from 10 to 500, preferably from 10 to 400, and more preferably from 20 to 400;
   A/O: 0.01 to 10, preferably from 0.1 to 8, preferably from 0.2 to 5;
ii) heat treatment of said precursor gel obtained on conclusion of step i) is carried out at a temperature of between 120° C. and 250° C., for a period of between 2 days and 21 days.

Preferably, the mixture obtained in step i) comprises the following molar composition:

Sn/Zn: at least 0.1;

S/(Sn+Zn): 0.1 to 20;

R/(Sn+Zn): 0.1 to 20.

Preferably, the mixture of step i) also comprises a solvent, denoted SOLV, said mixture comprising the following molar composition:

Sn/Zn: at least 0.1;

S/(Sn+Zn): 0.1 to 20;

R/(Sn+Zn): 0.1 to 20;

SOLV/(Sn+Zn): 10 to 1000.

In accordance with the process according to the invention, R is a nitrogenous organic compound having at least one nitrogen atom, preferably R comprises two nitrogen atoms, said compound being incorporated into the reaction mixture for the implementation of step i) as an organic structuring agent. Preferentially, R is the nitrogenous compound 1,3-bis(4-piperidinyl)propane. Said nitrogenous organic entity used as structuring agent for the crystalline solid IZM-5 can be synthesized by any method known to those skilled in the art.

In accordance with the process according to the invention, at least one source of tin is used in the reaction mixture of step i), and can be any compound comprising the element tin and which can release this element in the mixture in reactive form. The source of tin is preferably tin acetate Sn(CH₃CO₂)₄, tin tert-butoxide Sn(OC(CH₃)₃)₄, tin tetrachloride SnCl₄, tin bis(acetylacetonate) dichloride (CH₃COCH═C—(O⁻)CH₃)₂SnCl₂, tin oxide SnO₂, tin in metallic form Sn.

In accordance with the process according to the invention, at least one source of zinc is used in the reaction mixture of step i), and can be any compound comprising the element zinc and which can release this element in the mixture in reactive form. The source of zinc is preferably zinc chloride ZnCl₂, zinc acetate Zn(CH₃CO₂)₂, zinc sulfate ZnSO₄, zinc nitrate Zn(NO₃)₂, zinc oxide ZnO, zinc in metallic form Zn.

In accordance with the process according to the invention, at least one source of sulfur is used in the reaction mixture of step i), and can be any compound comprising the element sulfur and which can release this element in the mixture in reactive form. The source of sulfur is preferably solid or liquid under normal temperature and pressure conditions. The source of sulfur is preferably elemental sulfur S or S₈, sodium sulfide Na₂S, potassium sulfide K₂S, lithium sulfide Li₂S, ammonium sulfide S(NH₄)₂, dimethyl disulfide CH₃SSCH₃.

In accordance with the process according to the invention, optionally at least one solvent is used in the reaction mixture of step i), and can be an aqueous and/or organic compound. According to one variant, the solvent consists of an aqueous compound and an organic compound. The aqueous compound may be chosen from water H₂O, and the organic compound may be chosen from compounds which are liquid under normal temperature and pressure conditions, of the alcohol (preferably ethanol, isopropanol), diol (preferably ethylene glycol, propylene glycol), triol (preferably glycerol or propane-1,2,3-triol), organosulfur (preferably dimethyl sulfoxide or DMSO), or organonitrogen compound (preferably dimethylformamide or DMF) type.

According to another variant, no additional solvent is used in the process for preparing the crystalline solid IZM-5, and it is the nitrogenous organic entity denoted R when it is in liquid form under normal temperature and pressure conditions which enables the solubilization of the metal precursors and sulfur-bearing precursors.

Step i) of the process according to the invention consists in preparing a reaction mixture, called gel, and containing at least one source of tin, one source of zinc, one source of sulfur, at least one nitrogenous organic entity R, and optionally a solvent. The amounts of said reagents are adjusted as indicated above so as to confer on this gel a composition allowing its crystallization as crystalline solid IZM-5 in its crude synthesis form.

The mixing step i) is performed until a homogeneous mixture is obtained, preferably for a time of greater than or equal to 15 minutes, preferably with stirring by any system known to those skilled in the art, at a low or high shear rate. At the end of step i), a homogeneous precursor gel is obtained.

It may be advantageous to add seeds to the reaction mixture during said step i) of the process according to the invention so as to reduce the time required for the formation of the crystals and/or the total crystallization time. Said seeds also promote the formation of the crystalline solid IZM-5 to the detriment of impurities. Such seeds comprise crystalline solids, notably solid IZM-5 crystals. The crystal seeds are generally added in a proportion of between 0.01% and 10% by weight relative to the total weight of the tin precursors and zinc precursors used in the reaction mixture.

It may be advantageous to implement a maturing of the reaction mixture during step i), before the heat treatment ii) of the process according to the invention in order to control the size of the crystals of the crystalline solid IZM-5. Said maturing also promotes the formation of the crystalline solid IZM-5 to the detriment of impurities. The maturing of the reaction mixture during said step i) of the process according to the invention may be performed at ambient temperature or at a temperature of between 20 and 100° C. with or without stirring, for a time advantageously of between 30 minutes and 48 hours.

In accordance with step ii) of the process according to the invention, the precursor gel obtained at the end of step i) is subjected to a heat treatment, preferentially carried out at a temperature of between 120° C. and 250° C. for a period of between 2 days and 21 days until the crystalline solid IZM-5 is formed.

The gel is advantageously placed under an autogenous reaction pressure, optionally with addition of gas, for example nitrogen, at a temperature of between 120° C. and 250° C., preferably between 140° C. and 210° C. until crystals of solid IZM-5 in its crude synthesis form have formed.

The time required to obtain crystallization generally ranges between 1 day and several months as a function of the composition of the reagents in the gel, the stirring and the reaction temperature. Preferably, the crystallization time ranges between 2 days and 21 days and preferably between 5 days and 15 days.

The reaction is generally carried out with or without stirring, preferably with stirring. The stirring system that may be used is any system known to those skilled in the art, for example inclined blades with counter-blades, stirring turbomixers or Archimedes' screws.

At the end of the reaction, after carrying out said step ii) of the preparation process according to the invention, the solid phase made up of an IZM-5 solid is preferably filtered, washed and then dried. Preferably, the washing step will be carried out with ethanol or with the solvent used for the synthesis. The drying is generally performed at a temperature of between 20° C. and 150° C., preferably between 60° C. and 100° C., for a period of between 5 hours and 24 hours.

At the end of said drying step, the IZM-5 solid obtained is the one having the X-ray diffraction pattern including at least the lines listed in table 1.

After step ii), and optionally after the filtering, washing and drying steps as described above, a step of extracting the organic entity R may be implemented in order to release the microporosity by any method known to those skilled in the art. Preferably, this step can be carried out using a heat treatment of 100° C. to 1000° C. under air, under oxygen, under hydrogen, under H₂S or else under inert gas such as N₂, alone or as a mixture. This extraction can also be done by ion exchange with entities such as NH₄+, alkalis, alkaline earth metals or any metal cation.

After extraction of the organic entity R, the crystalline solid IZM-5 according to the invention can be used as an adsorbent, for example, for pollution control or as a molecular sieve for the separation.

### EXAMPLES

The invention is illustrated by the following examples, which are not in any way limiting.

### Example 1: Preparation of an IZM-5 Solid According to the Invention

0.228 g of tin dioxide (SnO₂, purity 99% by weight, Sigma-Aldrich) were mixed with 0.146 g of zinc nitrate (Zn(NO₃)₂.6H₂O, purity 99% by weight, Alfa Aesar). Subsequently, 0.277 g of sulfur (S, purity 99.98% by weight, Aldrich) and 2.001 g of 1,3-bis(4-piperidyl)propane (compound R, purity 97% by weight, Aldrich) are added to the previous mixture. In the end, 11.2 ml of ethylene glycol (purity 99.8% by weight, VWR) and 3.7 ml of deionized water are incorporated and the synthesis gel is kept stirring (250 rpm) for 30 minutes. The precursor gel is then transferred, after homogenization, into an autoclave. The autoclave is closed and then heated for 12 days at 190° C. under static conditions. The crystalline product obtained is filtered, washed with ethanol and then dried overnight at 100° C. The crude solid synthesis product was analyzed by X-ray diffraction and identified as consisting of solid IZM-5. The diffraction pattern produced for the crude IZM-5 synthesis solid is given in FIG. 2. The product has an Sn/Zn molar ratio of 5.7 as determined by ICP-MS. Elemental analysis gives the following molar composition: Sn_{3.4}Zn_{0.6}S₈:1.1R.

### Example 2: Preparation of an IZM-5 Solid According to the Invention

0.293 g of tin dioxide (SnO₂, purity 99% by weight, Sigma-Aldrich) were mixed with 0.141 g of zinc nitrate (Zn(NO₃)₂.6H₂O, purity 99% by weight, Alfa Aesar). Subsequently, 0.267 g of sulfur (purity 99.98% by weight, Aldrich) and 2.002 g of 1,3-bis(4-piperidyl)propane (compound R, purity 97% by weight, Aldrich) are added to the previous mixture. In the end, 11.5 ml of ethylene glycol (purity 99.8% by weight, VWR) and 3.6 ml of deionized water are incorporated and the synthesis gel is kept stirring (250 rpm) for 30 minutes. The precursor gel is then transferred, after homogenization, into an autoclave. The autoclave is closed and then heated for 12 days at 190° C. under static conditions. The crystalline product obtained is filtered, washed with ethanol and then dried overnight at 100° C. The crude solid synthesis product was analyzed by X-ray diffraction and identified as consisting of IZM-5 solid with traces of SnO. The product has an Sn/Zn molar ratio of 5.8 as determined by ICP-MS.

Elemental analysis gives the following molar composition: Sn_{3.5}Zn_{0.6}S₈:1R.

### Example 3: Preparation of an IZM-5 Solid According to the Invention

0.240 g of tin metal (Sn°, purity 99% by weight, Sigma-Aldrich) were mixed with 0.144 g of zinc nitrate (Zn(NO₃)₂.6H₂O, purity 99% by weight, Alfa Aesar). Subsequently, 0.276 g of sulfur (S, purity 99.98% by weight, Aldrich) and 2.000 g of 1,3-bis(4-piperidyl)propane (compound R, purity 97% by weight, Aldrich) are added to the previous mixture. In the end, 11.2 ml of ethylene glycol (purity 99.8% by weight, VWR) and 3.7 ml of deionized water are incorporated and the synthesis gel is kept stirring (250 rpm) for 30 minutes. The precursor gel is then transferred, after homogenization, into an autoclave. The autoclave is closed and then heated for 12 days at 190° C. under static conditions. The crystalline product obtained is filtered, washed with ethanol and then dried overnight at 100° C. The crude solid synthesis product was analyzed by X-ray diffraction and identified as consisting of IZM-5 solid with traces of Sn°. The product has an Sn/Zn molar ratio of 5.9 as determined by ICP-MS. Elemental analysis gives the following molar composition: Sn_{3.7}Zn_{0.6}S₈:0.95R.

1. A crystalline solid comprising a chemical composition, expressed on an anhydrous basis, in terms of moles, defined by the following general formula:
SnₐZn_{b}S₈:cR
wherein
R represents at least one nitrogenous organic entity;
S is sulfur;
“a” is the molar amount of tin, denoted Sn, between 0.1 and 5;
“b” is the molar amount of zinc, denoted Zn, between 0.2 and 8;
“c” is the molar amount of the nitrogenous organic entity R between 0 and 4.

2. The crystalline solid as claimed in claim 1, wherein “c” is between 0.2 and 4.

3. The crystalline solid as claimed in claim 2, said solid exhibiting an X-ray diffraction pattern including at least the lines listed in the table below:
TABLE 3

| 2 theta (°) | dhkl (Å) | Irel |
|---|---|---|
| 7.95 | 11.11 | St |
| 8.88 | 9.95 | m |
| 10.18 | 8.68 | w |
| 11.10 | 7.97 | VSt |
| 11.72 | 7.54 | St |
| 15.37 | 5.76 | m |
| 16.71 | 5.30 | w |
| 17.36 | 5.11 | w |
| 21.49 | 4.13 | m |
| 22.30 | 3.98 | m |
| 23.31 | 3.81 | w |
| 30.05 | 2.97 | w |
| 33.34 | 2.69 | w |
| 35.96 | 2.50 | w |
| 40.80 | 2.21 | w |

where VSt = very strong;
St = strong;
m = medium;
w = weak.

4. The crystalline solid as claimed in claim 1, wherein “a” is between 1 and 4.

5. The crystalline solid as claimed in claim 1, wherein “b” is between 0.2 and 2.

6. The crystalline solid as claimed in claim 2, wherein “c” is between 0.5 and 3.

7. The crystalline solid as claimed in claim 1, wherein R is an organic compound comprising at least two nitrogen atoms.

8. The crystalline solid as claimed in claim 7, wherein R is 1,3-bis(4-piperidinyl)propane.

9. A process for preparing a crystalline solid as claimed in claim 1, comprising the following steps:
i) at least one source of tin, denoted Sn, at least one source of zinc, denoted Zn, at least one source of sulfur, denoted S, at least one nitrogenous organic compound, denoted R, are mixed to obtain a precursor gel;
ii) heat treatment of said precursor gel obtained on conclusion of step i) is carried out at a temperature of between 120° C. and 250° C., for a period of between 2 days and 21 days.

10. The process as claimed in claim 9, wherein the mixture of step i) comprises the following molar composition:
Sn/Zn: at least 0.1;
S/(Sn+Zn): 0.1 to 20;
R/(Sn+Zn): 0.1 to 20.

11. The process as claimed in claim 9, wherein the mixture of step i) also comprises at least one solvent denoted SOLV comprising at least one aqueous compound (denoted A) and/or at least one organic compound (denoted O) for obtaining a precursor gel, said mixture comprising the following molar composition:
Sn/Zn: at least 0.1;
S/(Sn+Zn): 0.1 to 20;
R/(Sn+Zn): 0.1 to 20;
SOLV/(Sn+Zn): 10 to 1000;
A/O: 0.01 to 10.

12. The process as claimed in claim 9, wherein the source of tin is chosen from tin acetate Sn(CH₃CO₂)₄, tin tert-butoxide Sn(OC(CH₃)₃)₄, tin tetrachloride SnCl₄, tin bis(acetylacetonate) dichloride (CH₃COCH═C—(O⁻)CH₃)₂SnCl₂, tin oxide SnO₂, tin in metallic form Sn.

13. The process as claimed in claim 9, wherein the source of zinc is chosen from zinc chloride ZnCl₂, zinc acetate Zn(CH₃CO₂)₂, zinc sulfate ZnSO₄, zinc nitrate Zn(NO₃)₂, zinc oxide ZnO, zinc in metallic form Zn.

14. The process as claimed in claim 9, wherein the source of sulfur is chosen from elemental sulfur S or S₈, sodium sulfide Na₂S, potassium sulfide K₂S, lithium sulfide Li₂S, ammonium sulfide S(NH₄)₂, dimethyl disulfide CH₃SSCH₃.
